(19) United States
(12) Patent Application Publication
(10) Pub. No.: US 2006/0073751 A1
(43) Pub. Date: Apr. 6, 2006

(54) Interwoven belt fabric

(75) Inventor: Edward T Mol, Marne, MI (US)

Correspondence Address: MCGARRY BAIR PC, 171 MONROE AVENUE, N.W., SUITE 600, GRAND RAPIDS, MI, 49503, US

(73) Assignee: Mol Belting Company

(21) Appl. No.: 10/543,194

(22) PCT Filed: Nov. 18, 2003
(86) PCT No.: PCT/US03/37015

§ 371 Date: Jul. 21, 2005

(51) Int. Cl. B32B 5/22

(52) U.S. Cl. 442/76

(57) ABSTRACT

An interwoven belting fabric for use in conveyors, including treadmills, is constructed of a dual layer of weft yarns comprising adjacent couplets, a plurality of middle warp yarns, and a plurality of binder warp yarns. Each middle warp yarn is heat set under tension so that it is sufficiently straight and inelastic to bear loads under tension without twisting or stretching.

### BACKGROUND OF THE INVENTION

1. Field of the Invention

This invention relates to belts for use on conveyors, treadmills, and the like, and more particularly to an interwoven belt fabric for use in such belts.

2. Background Art

Endless belts are typically formed by joining opposite ends of a section of belt material and used in a number of different applications. One commonly known application for such endless belts is in physical exercise equipment such as treadmills, as well as in various material handling applications such as check-out counters in stores, and the like.

In a treadmill used for physical exercise, a motor driven belt extends over a flat running deck. The typical treadmill belt consists of woven material provided with a top layer of polyvinyl chloride or the like. Since the woven belt material forming the bottom surface of the woven belt is forced into contact with the top surface of the running deck by the weight of the person using the exercise equipment, the belt preferably has specific characteristics such that the belt has a low coefficient of friction with the deck, has a consistent stability when under load, produces a minimum noise and provides enhanced performance with the addition of lubricants between the surface of the deck and the belt.

The type of fabric used, to a very large extent, determines certain characteristics of the belt, such as the coefficient of friction, ability to dissipate heat, ability to absorb lubricants, stability, and noise generation. Typically, in prior art belts, the quieter belts have a higher coefficient of friction and belts made with a multi-filament warp yarns (i.e., yarns with long staple lengths) tend to have a lower coefficient of friction than spun warp yarns (i.e., yarns with short staple lengths). Furthermore, treadmill belts made with a typical plain weave fabric using multi-filament warp yarns and monofilament fibers in the weft generally have a relatively low coefficient of friction, but generate a relatively high level of noise.

In a typical prior art plain weave fabric, multi-filament warp yarn is alternately woven over and under a series of adjacently disposed monofilament weft fibers. In one prior art belt fabric, referred to as a one-by-three whisper weave-broken twill fabric, a multi-filament warp extends over one monofilament weft and under three monofilament controller is manually operable from a location remote from the latches such that the latches are manually and remotely controlled

In another embodiment, the present invention is a fingerboard having at least one fingerboard row for storing a plurality of threaded tubulars. A plurality of latches are connected to the at least one fingerboard row, wherein each of the plurality of latches is biased into a locked position and movable between the locked position and an unlocked position. A piston having an elongated rod is slidingly engaged with a casing, wherein the casing has a plurality of exhaust ports in fluid connection therewith, and wherein each of the plurality of exhaust ports is connected to a corresponding one of the plurality of latches. An air source is in fluid connection with the casing, wherein the elongated rod is movable between a fully retracted position and a plurality of extended positions corresponding to each of the plurality of exhaust ports, wherein in the fully retracted position each of the exhaust ports are covered by the elongated rod, such that air from the air source cannot flow therethrough allowing each of the corresponding latches to be biased in the locked position, and wherein in each successive one of the plurality of extended positions a successive one of the plurality of exhaust ports is uncovered such that air flows therethrough to force a successive one of the corresponding latches to move from the locked position to the unlocked position.

In yet another embodiment, the present invention is a fingerboard having at least one fingerboard row for storing a plurality of threaded tubulars. A plurality of latches are connected to the at least one fingerboard row, wherein each of the plurality of latches is biased into a locked position and movable between the locked position and an unlocked position. A piston having an elongated rod is slidingly engaged with a casing, wherein the casing has a plurality of exhaust ports in fluid connection therewith. Each of a plurality of conduits fluidly connects one of the plurality of exhaust ports to a corresponding one of the plurality of latches. An air source is in fluid connection with the casing, wherein the elongated rod is movable between a fully retracted position and a plurality of extended positions corresponding to each of the plurality of exhaust ports, wherein in the fully retracted position each of the exhaust ports are covered by the elongated rod, such that air from the air source cannot flow therethrough allowing each of the corresponding latches to be biased in the locked position, and wherein in each successive one of the plurality of extended positions a successive one of the plurality of exhaust ports is uncovered such that air flows therethrough to force a successive one of the corresponding latches to move from the locked position to the unlocked position. A piston guide is connected to the piston and has a plurality of stop positions, wherein each of the plurality of stop positions corresponds to one of the plurality of extended positions of the elongated rod.

In still yet another embodiment, the present invention is a method of storing a plurality of threaded tubulars in a fingerboard including providing a fingerboard row for storing the plurality of threaded tubulars; providing a casing having a plurality of exhaust wefts. Another prior art belt fabric, referred to as an interwoven fabric, has a layer of upper monofilament weft yarns and a layer of lower monofilament weft yarns. The two layers are separated by a light denier yarn and each of a plurality of multi-filament warp binder yarns extend under one of the lower monofilament weft yarns and over an adjacent upper monofilament weft yarn.

A problem with the prior art one-ply plain weave and whisper weave belts, when used in a treadmill belt or the like, is that they lack the desired stiffness required under various loads and at various speeds. When such materials are used, a two ply belt is typically required to obtain the desired stiffness. However, two ply belts are considerably more expensive to produce than single ply belts. For example, the manufacture of a two-layer belt may require as many as five passes through a belt making machine, one for the inner layer, one for the cover and three for the glue layers.

Prior art interwoven fabrics are generally considered to be undesirable for use in belts, because belts made of such fabrics are relatively noisy and the fabric typically has to be saturated with a plastic material to prevent the weft yarns from migrating out of the side of the belt.

Treadmill belts typically are operated at a higher speed than standard conveyer belts used for material handling and are typically subjected to greater concentrated loads as a result of the running action of a person on the belt. Hence, treadmill belts must be relatively stiff, particularly in the lateral direction. Such stiffness is generally obtained in prior art belts by making a thicker one-ply belt or by using two-ply belts.

Prior art one-ply and two-ply belts are comprised of a single layer of fabric or a double layer of a fabric, respectively, and a top cover layer of rubber or vinyl, or the like. The majority of such belts use monofilament yarns in their weft since material of that construction typically provides a relatively stable belt that lays flat, does not bunch up, and tracks straight. Generally, thicker belts are more stable than thinner belts and two-ply belts are more stable than one-ply belts.

However, thicker belts are typically relatively heavy and stiff in the longitudinal direction, thereby presenting a relatively higher load to the electric motor used to drive the belt. The higher load to the motor requires that a larger, more expensive motor be used which typically draws more current, all of which adds to the cost of the equipment and its operation. Therefore, a light weight, highly flexible, low friction belt is clearly desirable for applications such as treadmills. Furthermore, treadmill belts are subjected to much greater speed variations than standard conveyer belts. Hence, a belt for use in a treadmill application must be stable at high speeds as well as at low speeds.

To reduce power consumption and the generation of heat, it is desirable to reduce friction between the belt and the running deck. Hence, belts with a low coefficient of friction are preferred. Additionally, lubricants are often applied between the belt and the running deck to further reduce friction. A lubricant such as paraffin wax, Teflon®, or solventless silicone is commonly used to reduce friction between the belt and the deck. In order for a lubricant to be used effectively, however, the belt must be able to absorb a certain amount of the lubricant. Certain prior art plain weave and interwoven belts having monofilament yarns in their weft, have the desirable properties that they tend to lay flat, do not bunch up, and track straight. However, such belts do not absorb or hold lubricants well.

An interwoven fabric disclosed in U.S. Pat. No. 6,328,077 is two-ply fabric made of two layers of weft yarns in couplets, with warp yarns extending over and under adjacent couplets in a pattern where warp yarns extend under more couplets in the lower layer than extend over couplets in the upper layer. A central warp yarn of standard light denier extends between the upper and lower layers. This fabric works well as a solution to the aforementioned problems, but an improvement has been discovered that more effectively performs.

### SUMMARY OF THE INVENTION

According to the invention, a belting fabric comprises a plurality of adjacently disposed couplets of weft yarns, a plurality of binder warp yarns, and a plurality of middle warp yarns. The couplets form an upper layer of weft yarns and a lower layer of weft yarns. The binder warp yarns each extend over at least one of the couplets of weft yarns in the upper layer and under at least two of said adjacently disposed couplets of weft yarns in the lower layer. The middle warp yarns extend between the upper layer and the lower layers and are sufficiently straight and inelastic to bear loads under tension without twisting or stretching.

Preferably, the middle warp yarns are formed of PET and have a denier of at least 550. Also, preferably, the middle warp yarns are heat set under tension.

In another aspect of the invention a method of making a belting fabric includes the steps of arranging a plurality of couplets of weft yarns adjacent one another into an upper layer of weft yarns and a lower layer of weft yarns and weaving a plurality of middle warp yarns between the upper and lower layers. Also, a first warp yarn is woven over a first of said couplets of weft yarns and under a second and a third of the couplets of weft yarns, disposed adjacent the first of the couplets, a second warp yarn over a second of the couplets of weft yarns and under a third and fourth of the couplets of weft yarns, disposed adjacent the second of the couplets; and a third warp yarn over a third of the couplets of weft yarns and under fourth and fifth of the couplets of weft yarns, disposed adjacent the third of the couplets. Finally, the middle warp yarns are heat set.

### BRIEF DESCRIPTION OF THE DRAWINGS

FIG. 1 is side elevational view of a section of conveyer belting material incorporating the principles of the invention;

FIG. 2 is an enlarged side elevational view of the belting fabric of FIG. 1, having a weave pattern in accordance with principles of the invention;

FIG. 3 illustrates the pattern of a single warp binder yarn in the weave pattern of FIG. 2;

FIG. 4 is an enlarged side elevational view of a section of conveyer belting fabric of FIG. 1 having an alternate weave pattern in accordance with principles of the invention; and

FIG. 5 illustrates the pattern of a single warp binder yarn in the weave pattern of FIG. 4.

### DETAILED DESCRIPTION

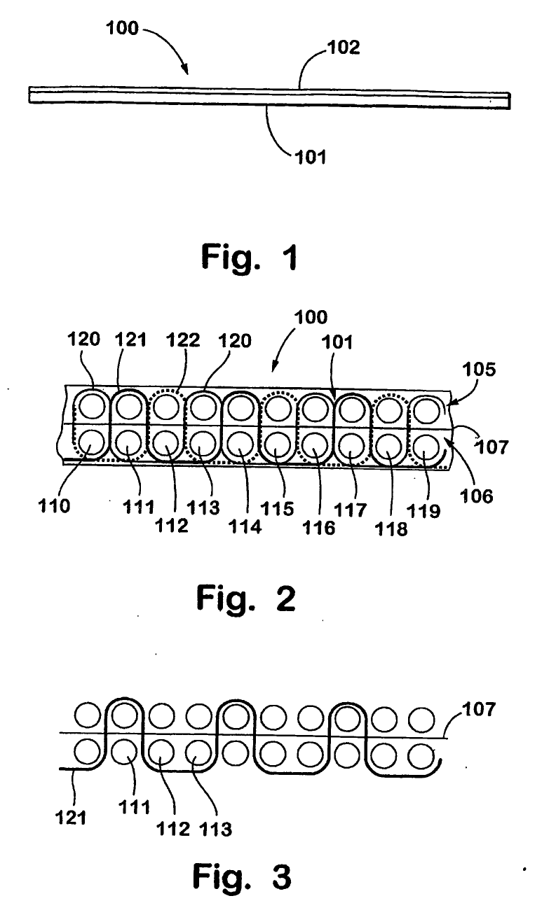

Shown in FIG. 1 is a section of conveyor belting material 100 comprising a fabric layer 101 and a cover layer 102. The cover layer 102 may be a standard rubber or plasticized polyvinyl material or the like. One embodiment of a belting fabric 100 in accordance with the invention is illustrated in FIG. 2 in an enlarged side elevational view of a portion of the belt 100. The belting fabric of FIG. 2 includes an upper layer of monofilament weft yarns 105 and a lower layer of monofilament weft yarns 106. The individual weft yarns of layer 105 are disposed in substantial alignment with individual weft yarns of layer 106, forming a plurality of couplets, 110 through 119. The monofilament weft yarns preferably have a diameter of approximately 0.3 mm.

The two layers of weft yarns 105, 106 are separated by inelastic middle warp yarns 107 in accordance with the invention. The middle warp yarns are sufficiently straight and inelastic to bear loads under tension without twisting or stretching. Each middle warp yarn 107 is preferably formed of PET having a denier of 550, although any polymer, rendered effectively inelastic, will suffice. The middle warp yarns 107 are heat set under tension to make them straight and inelastic.

A plurality of binder warp yarns 120,121,122 are woven on the weft yarns to form a belt fabric. The fabric layer 101 is woven in a repeating weaving pattern wherein three binder warp yarns 120, 121, and 122 are woven through a plurality of adjacently disposed couplets formed from aligned pairs of weft yarns of layers 105 and 106, in a specified pattern. In this pattern the first binder warp yarn 120 extends over a first aligned couplet of weft yarns 110 and under second and third couplets 111, 112, respectively; the second binder warp yarn 121 extends over the second couplet 111 and under third and fourth couplets 112,113, respectively; and the third binder warp yarn 122 extends over the third couplet 122 and under fourth and fifth couplets 113,114, respectively.

The specific pattern of the warp yarns shown in FIG. 2 is further illustrated in FIG. 3 in which the pattern of a single binder warp yarn 120 is shown separate from the other binder warp yarns.

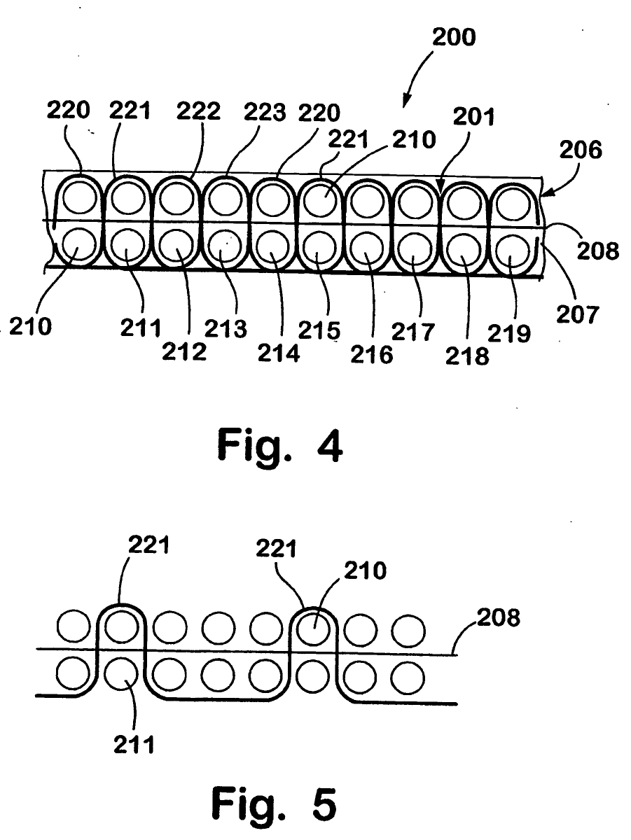

FIG. 4 depicts an alternate embodiment of a belt 200 in accordance with the invention wherein the fabric 201 comprises four binder warp yarns 220, 221, 222, and 223 woven into two layers of weft yarns 206,207. The layers of weft yarns 206,207 are separated by inelastic middle warp yarns 208 in accord with the invention. As before, each middle warp yarn 107 is preferably formed of PET having a denier of 550, although any polymer, rendered effectively inelastic, will suffice. The middle warp yarns 107 are heat set under tension to make them straight and inelastic.

The binder warp yarns 220, 221, 222, 223 are preferably 1,000 denier yarns and the weft yarns 206,207 are preferably approximately 0.3 mm monofilament yarns. The fabric 201 is woven in a repeating weaving pattern wherein four binder warp yarns 220, 221, 222 and 223 are woven in a specified pattern through a plurality of couplets formed from pairs of aligned weft yarns of layers 206, 207. In this pattern the first binder warp yarn 220 extends over a first aligned couplet of weft yarns 210 and under the second, third and fourth couplets 211, 212 and 213, respectively; the second warp yarn 221 extends over the second couplet of weft yarns 211 and under the third, fourth and fifth couplets 212, 213 and 214, respectively; the third warp yarn 222 extends over the third couplet of weft yarns 212 and under the fourth, fifth and sixth couplets 213, 214 and 215, respectively; and the fourth warp yarn 223 extends over the fourth couplet of weft yarns 213 and under the fifth, sixth and seventh couplets 214, 215 and 216, respectively.

The specific pattern of the binder yarns of FIG. 4 is further illustrated in FIG. 5 in which the pattern of a single binder warp yarn, yarn 221, is shown separate from the other binder warp yarns.

Belt material in accordance with the present invention is preferably manufactured by feeding the woven belt fabric, e.g., 100, 200, from a roll of the fabric into a well-known belt coating apparatus. Such apparatus typically includes a feeding mechanism extending the belt between a roller and a coating knife. Liquid PVC, such as a well-known product referred to in the trade as “Plastisol,” is applied in a standard fashion. The belt material with the newly applied coating is then fed into an oven and heated by infrared lamps or the like to dissolve the applied PVC. After passing through the oven, the belt material with the applied PVC is fed between a roller and a cooling drum while cooling the belt. This causes the PVC to be forced into cavities in the woven material.

One advantage of the belting fabric is that it has cavities of substantial size that provide for proper adhesion of the PVC layer to the fabric. As a result, glue lining required for belts made of prior art belt fabrics is not required. The application of such a glue lining requires that the belt material be fed through a glue application mechanism, similar to the PVC application mechanism. Accordingly, a belt made in accordance with the present invention is substantially less expensive to manufacture. More importantly, however, the stronger middle warp yarns are believed to be the ones primarily under tension during operation of the belt. Since they are the load-carrying yarns, the upper and lower layers on either side of the middle warp yarns are under no load, an thus do not wear as quickly as belts of the prior art. The result is a more durable belt.

1. A belting fabric comprising a plurality of adjacently disposed couplets of weft yarns forming an upper layer of weft yarns and a lower layer of weft yarns, a plurality of binder warp yarns each extending over at least one of the couplets of weft yarns in the upper layer and under at least two of said adjacently disposed couplets of weft yarns in the lower layer, and middle warp yarns between the upper layer and the lower layers, wherein the middle warp yarns are sufficiently straight and inelastic to bear loads under tension without twisting or stretching.

2. The belting fabric in accordance with claim 1 wherein the middle warp yarns are formed of PET.

3. The belting fabric in accordance with claim 1 wherein the middle warp yarns have a denier of at least 550.

4. The belting fabric in accordance with claim 1 wherein the middle warp yarns are heat set under tension.

5. The method of claim 9 wherein:
a first warp yarn is woven over a first of said couplets of weft yarns and under a second and a third of said couplets of weft yarns, disposed adjacent said first of said couplets;
a second warp yarn is woven over a second of said couplets of weft yarns and under a third and fourth of said couplets of weft yarns, disposed adjacent said second of said couplets; and
a third warp yarn is woven over a third of said couplets of weft yarns and under fourth and fifth of said couplets of weft yarns, disposed adjacent said third of said couplets.

6. The belting fabric in accordance with claim 2 wherein the middle warp yarns have a denier of at least 550.

7. The belting fabric in accordance with claim 2 wherein the middle warp yarns are heat set under tension.

8. The belting fabric in accordance with claim 3 wherein the middle warp yarns are heat set under tension.

9. A method of making a belting fabric, the method comprising the steps of:
arranging a plurality of couplets of weft yarns adjacent one another into an upper layer of weft yarns and a lower layer of weft yarns;
weaving a plurality of middle warp yarns between the upper and lower layers;
weaving a plurality of warp yarns over a first of said couplets of weft yarns and under a plurality of adjacent couplets of weft yarns; and
heat setting the middle warp yarns.

10. The method of claim 9 wherein the plurality of warp yarns is woven under two adjacent couplets of weft yarns.

11. The method of claim 9 wherein the plurality of warp yarns is woven under three adjacent couplets of weft yarns.

12. A conveyor belt comprising:
a belting fabric having a plurality of adjacently disposed couplets of weft yarns forming an upper layer of weft yarns and a lower layer of weft yarns, a plurality of binder warp yarns each extending over at least one of the couplets of weft yarns in the upper layer and under at least two of said adjacently disposed couplets of weft yarns in the lower layer, and middle warp yarns between the upper layer and the lower layers, wherein the middle warp yarns are sufficiently straight and inelastic to bear loads under tension without twisting or stretching; and
a cover layer.

13. The conveyor belt of claim 12 wherein the cover layer is formed of a material selected from rubber, plasticized polyvinyl, or PVC.

14. The conveyor belt of claim 12 wherein the middle warp yarns are formed of PET.

15. The conveyor belt of claim 14 wherein the middle warp yarns have a denier of at least 550.

16. The conveyor belt of claim 15 wherein the middle warp yarns are heat set under tension.

17. The conveyor belt of claim 12 wherein the middle warp yarns have a denier of at least 550.

18. The conveyor belt of claim 17 wherein the middle warp yarns are heat set under tension.

19. The conveyor belt of claim 12 wherein the middle warp yarns are heat set under tension.

20. The conveyor belt of claim 19 wherein the middle warp yarns are formed of PET.
